(19) United States
(12) Patent Application Publication
(10) Pub. No.: US 2003/0017362 A1
(43) Pub. Date: Jan. 23, 2003

(54) Uniaxial, high moment FeCo alloys

(76) Inventors: Michael Kevin Minor, Gibsonia, PA (US); Robert Earl Rottmayer, Wexford, PA (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 09/683,634

(22) Filed: Jan. 29, 2002

Related U.S. Application Data
(60) Provisional application No. 60/306,067, filed on Jul. 17, 2001.

(51) Int. Cl. B32B 9/00

(52) U.S. Cl. 428/692; 428/694 ML

(57) ABSTRACT

A process for producing an iron cobalt alloy exhibiting magnetic anisotropy is disclosed. The alloy also exhibits a high magnetic moment, low coercivity and has uniaxial properties, making it suitable for use as the top pole of a magnetic recording head. The change in magnetic properties is brought about through the application of a high bias voltage during the deposition process.

### RELATED APPLICATIONS

Referenced-Applications

This application claims the benefit of U.S. Provisional Application Serial No. 60/306,067, filed Jul. 17, 2001.

### FIELD OF THE INVENTION

This invention is related to the field of magnetic recording for the storage of data, and, in particular discloses an alloy and the means for making the alloy such that it is suitable for use as the top write pole for the recording head of a hard disc drive.

### BACKGROUND OF INVENTION

In a recording head for the recording of data onto a magnetic disc, two configurations are known in the art. In recording heads having a perpendicular geometry, the write field utilizes the deep gap field to write data onto the disc. In heads having a longitudinal geometry, the fringing field is utilized. When using a head having a perpendicular geometry, the effective write field of the head is related to the saturation magnetization (4πMₛ) of the material. It is therefore desirable, when using a head having perpendicular geometry, to provide a write pole having a tip composed of a material having a relatively high saturation magnetization, which would be capable of passing large amounts of flux through the media and back into the opposing pole of the recording head.

At room temperature, the highest saturation magnetization known is provided by an alloy of iron (Fe) and cobalt (Co). Iron has a magnetic moment of ˜2.2T, while cobalt has a magnetic moment of ˜1.8T. It is well known in the art that the highest saturation magnetization is provided by an alloy of approximately 65 parts iron to 35 parts cobalt (Fe₆₅Co₃₅), which has a saturation magnetization of ˜2.4T.

To be suitable for use as a write pole tip, in addition to exhibiting a relatively high saturation magnetization, the material must also exhibit low coercivity and a well-defined uniaxial anisotropy. One problem with FeCo that prevents it from being used as a perpendicular pole tip is that the material is generally magnetically isotropic and exhibits a high coercivity. As a result, the material has a nearly zero permeability, which results in an inefficient write head. The lack of uniaxiality, or “magnetic softness,” of the FeCo is a direct result of the relatively large degree of magnetocrystalline anisotropy exhibited by the high moment FeCo alloys.

It would therefore be desirable overcome the magnetocrystalline anisotropy of the FeCo alloys, such that they exhibit the desired uniaxiality for maximum write head efficiency.

### SUMMARY OF INVENTION

The solution to the problem is to deposit the high moment FeCo alloys in such a way as to reduce or average out the magnetocrystalline anisotropy. One way to accomplish this is by producing an FeCo alloy which exhibits an average grain size which is less than the magnetic exchange length of the FeCo material. As is disclosed herein, this can be accomplished by the application of a large bias voltage during the ambient temperature physical vapor deposition of the FeCo alloy. The change in grain size due to the application of the bias voltage makes the material magnetically anisotropic, such that it exhibits uniaxiality, and, as a result, has “easy” and “hard” magnetic axes approximately 90 degrees apart. This provides the FeCo, when a field is applied along the hard axis, the desired permeability necessary for an efficient perpendicular top pole material.

### BRIEF DESCRIPTION OF DRAWINGS

FIG. 1 is a graph showing film thickness versus bias power for samples of a 50/50 FeCo alloy and a 65/35 FeCo alloy.

FIG. 2 is a graph of the applied bias voltage versus bias power.

FIG. 3 is a graph of thin film stress versus bias power for a 50/50 FeCo alloy and a 65/35 FeCo alloy along both easy and hard axes.

FIG. 4 shows MOKE loops for the easy axis for a 50/50 FeCo alloy at various bias power settings.

FIG. 5 shows MOKE loops for the hard axis for a 50/50 FeCo alloy at various bias power settings.

FIG. 6 shows expansion of a portion of FIGS. 4 and 5 showing the MOKE loop at 300 watt bias for a 50/50 FeCo alloy.

FIG. 7 shows a BH loop for a 50/50 FeCo alloy using a 300 watt bias.

FIG. 8 shows MOKE loops for the easy axis for a 65/35 FeCo alloy as a function of bias power.

FIG. 9 shows MOKE loops for the hard axis for a 65/35 FeCo alloy as a function of bias power.

FIG. 10 shows an enlarged portion of FIGS. 8 and 9 showing the MOKE loop of the 65/35 FeCo alloy at 200 watt bias.

FIG. 11 shows a BH loop of a 65/35 FeCo alloy at 200 watt bias.

FIG. 12 shows coercivity versus bias power for 50/50 and 65/35 FeCo alloys for both easy and hard axes.

FIG. 13 shows a graph of coercivity versus film stress for 50/50 and 65/35 FeCo alloys along both easy and hard axes for biases in the range of 0-900W.

FIG. 14 shows MOKE loops for a 65/35 FeCo alloy as a function of bias power.

FIG. 15 shows the BH loops for the easy axes for a 65/35 FeCo alloy as a function of bias power.

FIG. 16 is a graph of easy and hard axis coercivity, uniaxial anisotropy and squareness versus applied bias voltage for a 65/35 FeCo alloy.

FIG. 17 shows the BH loops for a 65/35 FeCo alloy with an applied bias of 900 watts for both the easy and hard axes.

### DETAILED DESCRIPTION

It is desirable to use an FeCo alloy to construct a top pole of the recording head of a magnetic disc drive because of the very large magnetic moment exhibited by the alloy, usually on the order of 2.4T. However, FeCo alloys are isotropic, which prevents their use as such. It has been discovered that the application of a bias voltages during deposition of Fe₅₀Co₅₀ and Fe₆₅Co₃₅ films results in a decreased coercivity and a degree of uniaxial anisotropy, which would allow them to be used as top pole material. Further, it has been found that it is not until the very high bias voltages of −400V and higher are used that the FeCo films are magnetically enhanced. This result is unique and cannot be found in the prior art.

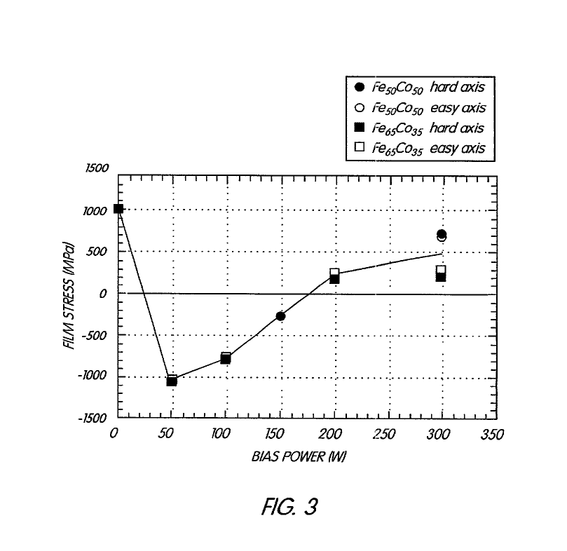

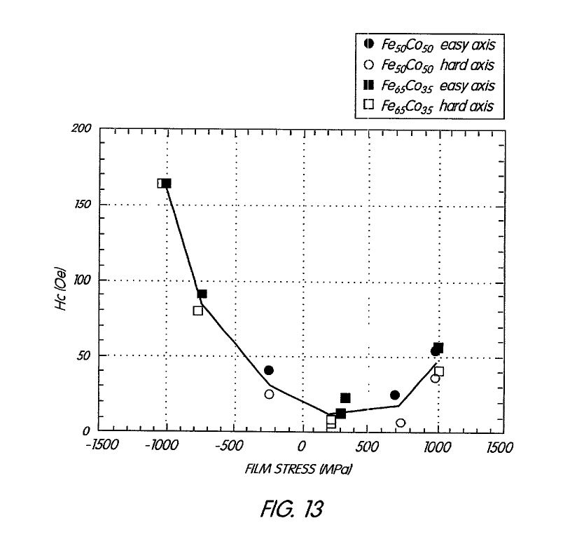

It is believed that this result is achieved because of a change in the film microstructure due to the application of the bias voltage. A change in microstructure can be demonstrated using film stress as an indicator. FIG. 3 shows a strong dependence on film stress versus bias power and FIG. 13 shows a strong correlation between film stress and coercivity. The only parameter that is changing is the application and the magnitude of a bias voltage applied during deposition. Therefore, we conclude that this bias voltage must change the film microstructure. This microstructural change is indirectly suggested by the behaviors of the film stress and magnetic properties as a function of bias voltage. It is believed that bias voltage results in energetics which transforms the microstructure from one with average in-plane grain sizes which are relatively large to one with reduced in-plane grain sizes. This reduced grain size structure is believed to exhibit an average in-plane grain size which is less than the exchange length of the FeCo. This allows the magnetocrystalline anisotropy of the FeCo to be effectively averaged out, thus allowing the FeCo to exhibit soft magnetic properties.

Experimental data was collected on two sets of films to prove the invention. The first set contains films with the structure: Si\SiO₂\Fe₅₀Co₅₀\50 Å Cr cap, which was deposited at bias powers of 0, 150, and 300W. The second set contains films with the structure: Si\SiO₂\Fe₆₅Co₃₅\50 Å Cr cap, which was also deposited at bias powers of 0, 50, 100, 200, and 300W.

These films were prepared via dc magnetron co-deposition from pure Fe and Co targets. The deposition pressure was 2.5 mtorr and UHP Ar was used as the process gas. Substrates were 150 mm round Si (100) with 5000 Å of thermal oxide. The substrates were rotating at 5 rpm and an rf bias was applied during deposition. Film composition was controlled by adjusting the flux from each target.

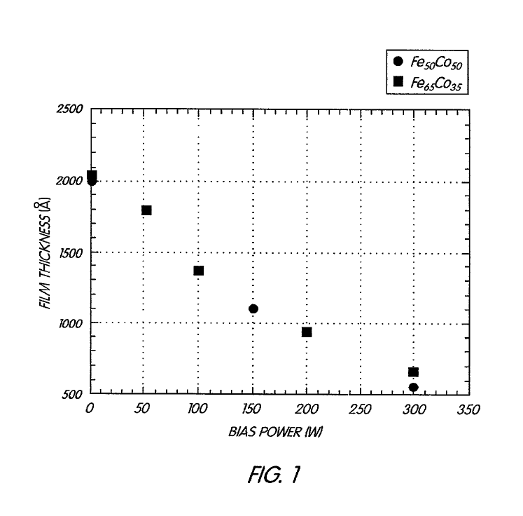

For the Fe₅₀Co₅₀, the flux from both the Fe and Co targets was 1.9 Å/s giving a total deposition rate of 3.8 Å/s. For the Fe₆₅Co₃₅, the flux from the Fe target was 1.77 Å/s and the flux from the Co target was 0.95 Å/s is giving a total deposition rate of 2.72 Å/s. The total time of deposition was kept constant and targeted to give 2000 Å of FeCo at 0W bias. Of course, the total flux reaching the substrate decreased with increasing bias power. The actual film thickness versus bias power is shown in FIG. 1.

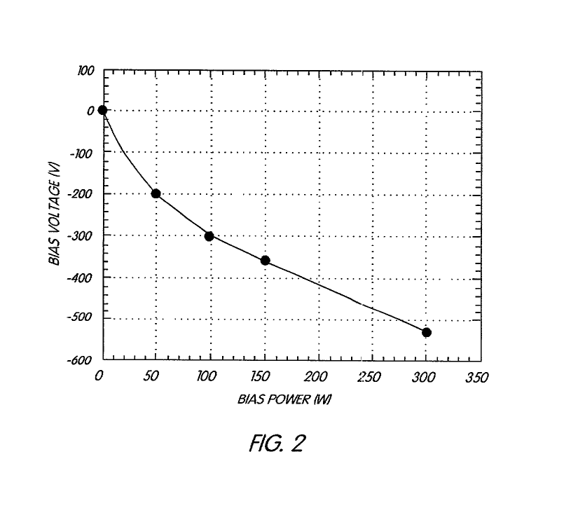

The co-deposition system applies an rf bias which is power controlled. FIG. 2 shows the actual bias voltage versus the applied rf bias power.

As previously stated, the alteration of the microstructure of the film may be responsible for the alteration of the film's magnetic properties. One of the simplest ways to monitor microstructural changes is to measure the film stress. Film stress was measured using the laser scanning technique in a KLA-Tencor thin film stress measurement system. Film stress was measured in two orthogonal directions which corresponded to the easy and hard axes of the films. The film stress versus bias power for the FeCo films is shown in FIG. 3.

It can be seen from FIG. 3 that, with the application of 50W of bias, the film stress changes from tensile to compressive with approximately the same magnitude. This indicates a structural change in the film morphology that will also be evident in the magnetic properties of the film. Increasing the bias power from 50W to 300W results in the film stress becoming more tensile, passing through zero at ˜175W, and then exhibiting a state of tension.

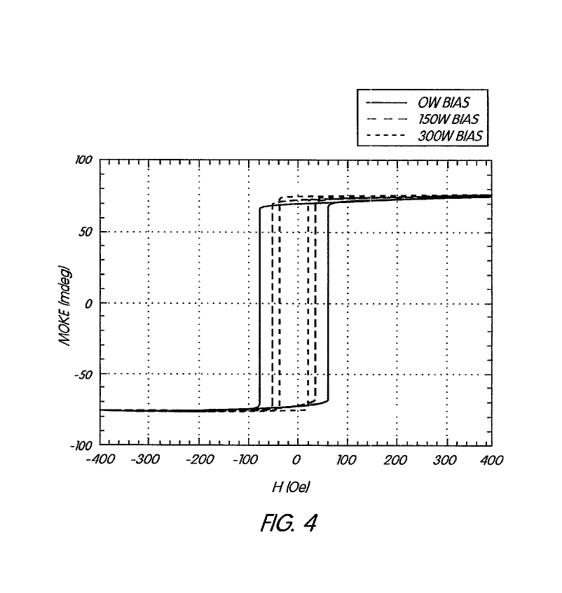

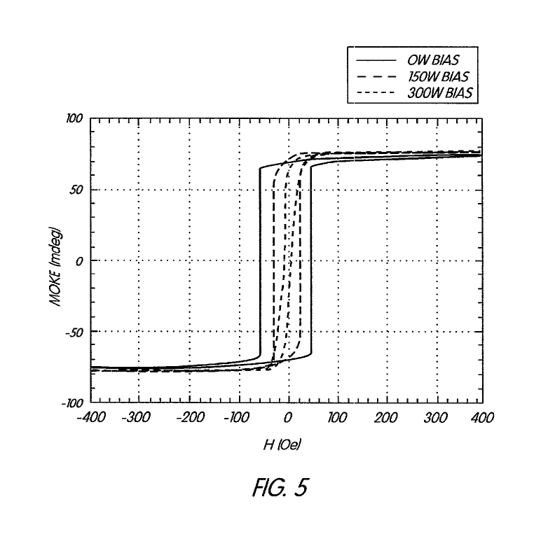

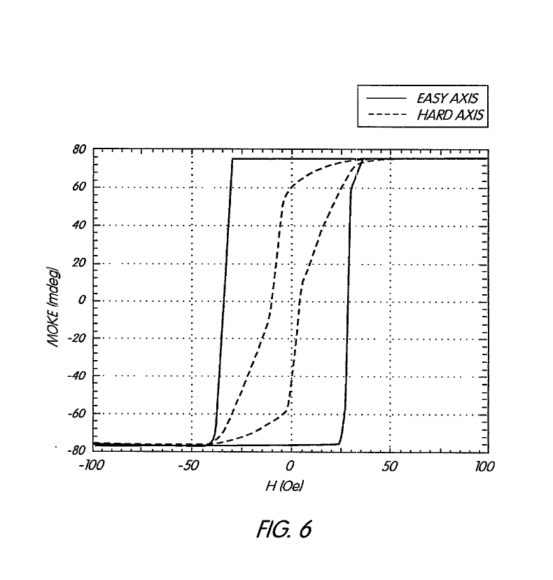

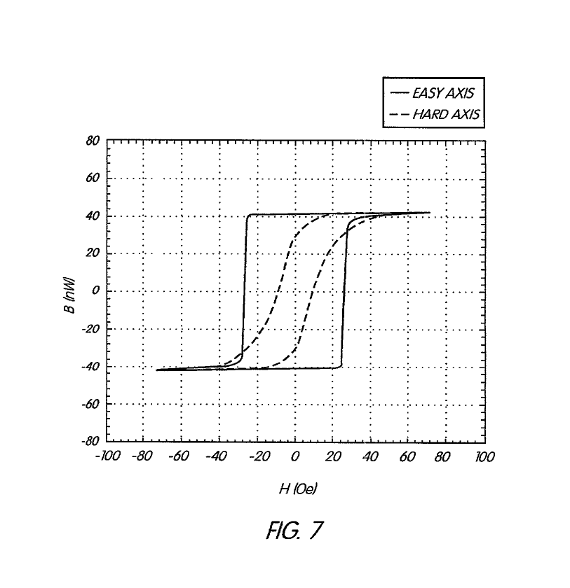

Magnetic properties of the FeCo films were measured with a magneto optical kerr effect (MOKE) mapper and an SHBR 109 RH looper. FIGS. 4 and 5 show the MOKE loops for the easy and hard axes of the Fe₅₀Co₅₀ films, respectively. FIGS. 4 and 5 show that as bias is increased, H_{C} decreases and squareness increases for the easy axis. Also at 300W bias, the film is showing some degree of uniaxiality. This is shown in FIGS. 6 and 7 which show the easy and hard axis loops for the 300W bias Fe₅₀Co₅₀ film from the MOKE and the BH looper, respectively.

FIGS. 6 and 7 show that Fe₅₀Co₅₀, which exhibits a moment of ˜2.4T, is not isotropic. On the contrary, Fe₅₀Co₅₀ grown with 300W bias exhibits a decreased coercivity and an H_{K} of ˜55 Oe. This result is unique and has not been found in the prior art for sputtered materials.

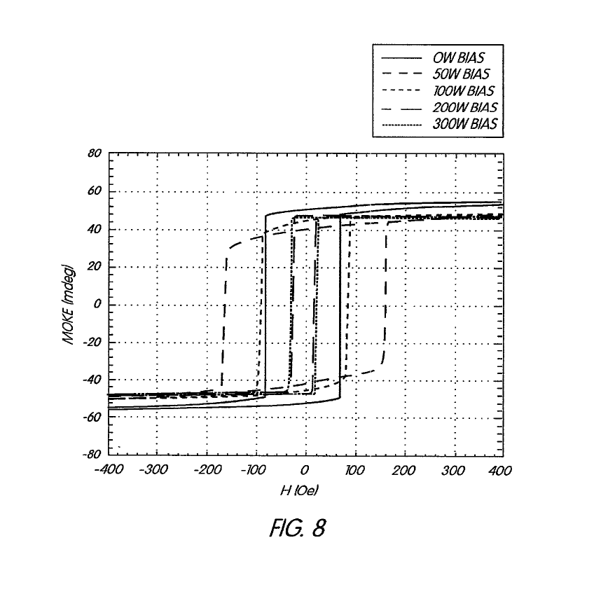

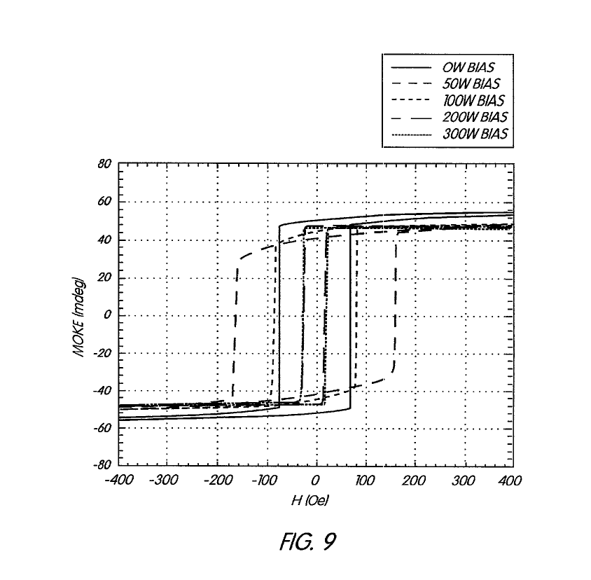

Even though Fe₅₀Co₅₀ exhibits a high moment, the highest moment FeCo composition is Fe₆₅Co₃₅. The second set of films shows the experimental data for the Fe₆₅Co₃₅. FIGS. 8 and 9 show the MOKE loops for the easy and hard axes of the Fe₆₅Co₃₅ films, respectively.

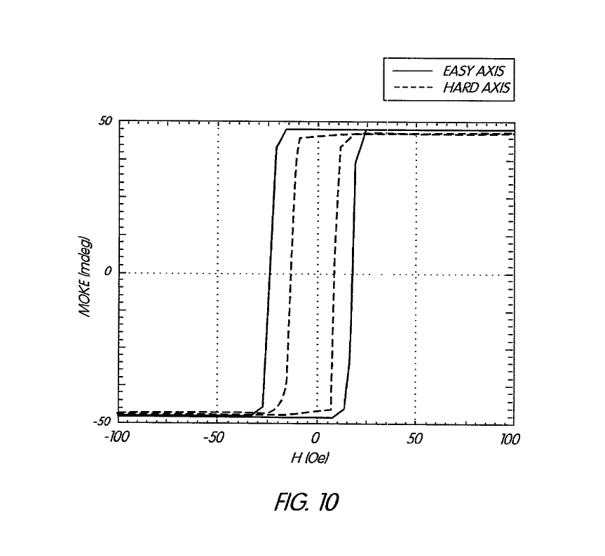

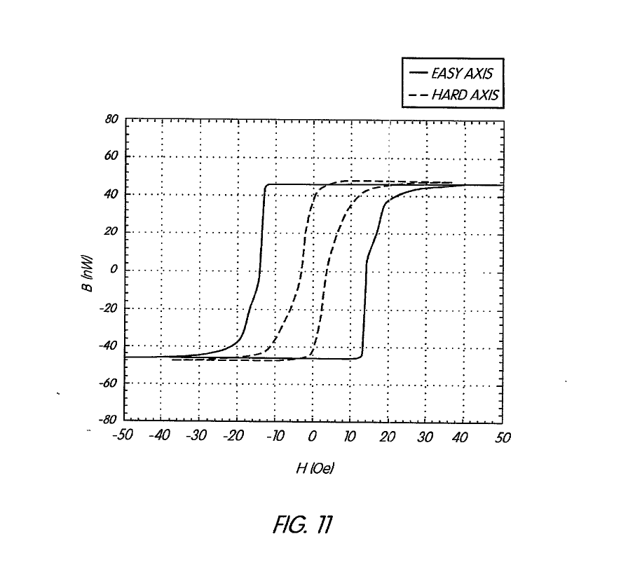

FIGS. 8 and 9 show that at 0W bias, Fe₆₅Co₃₅ is isotropic with a relatively large coercivity. At 50W bias the coercivity increases by almost a factor of 2. At 100W bias the coercivity begins to decrease, however, it is still larger than that at 0W bias. It is with the application of 200 and 300W bias that a dramatic decrease in coercivity is seen. The 200 and 300W bias films also exhibit some degree of uniaxiality. This is shown in FIGS. 10 and 11 which show the easy and hard axis loops for the 200W bias Fe₆₅Co₃₅ film from the MOKE and the BH looper, respectively.

FIGS. 10 and 11 show that Fe₆₅Co₃₅ can also be made to exhibit a decreased coercivity and some degree of uniaxiality (H_{K}˜33 Oe), as was the case of Fe₅₀Co₅₀.

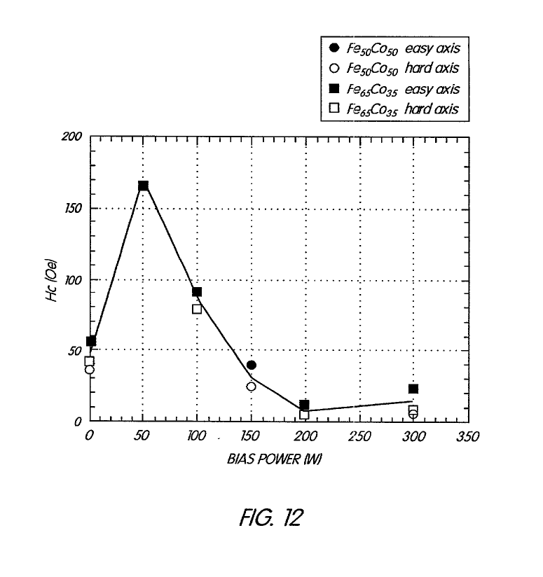

The easy and hard axis coercivities of the Fe₅₀Co₅₀ and the Fe₆₅Co₃₅ are shown versus bias power in FIG. 12. It can be seen that the coercivities versus bias power for both FeCo compositions are nearly the same. FIG. 12 could also explain why this desirable behavior has not been observed. At 50 and 100W bias, there is no improvement to the magnetic properties of FeCo; on the contrary, the magnetic properties are worse. The bias voltages that correspond to 50 and 100W are −200 and −300V, respectively. These voltages would be considered high and probably would not be exceeded in practice.

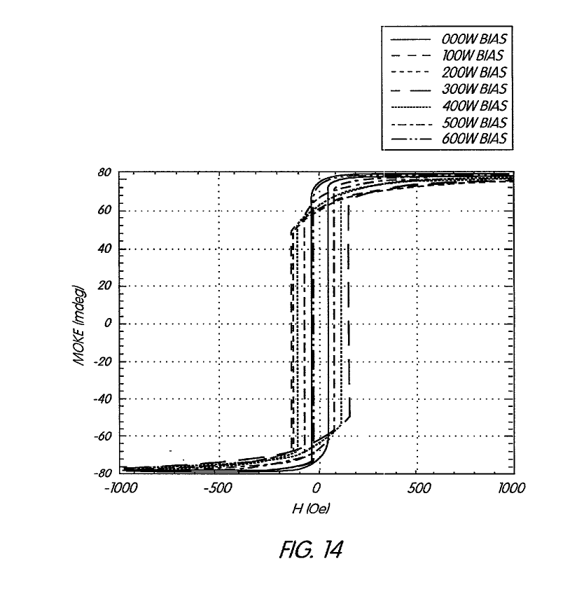

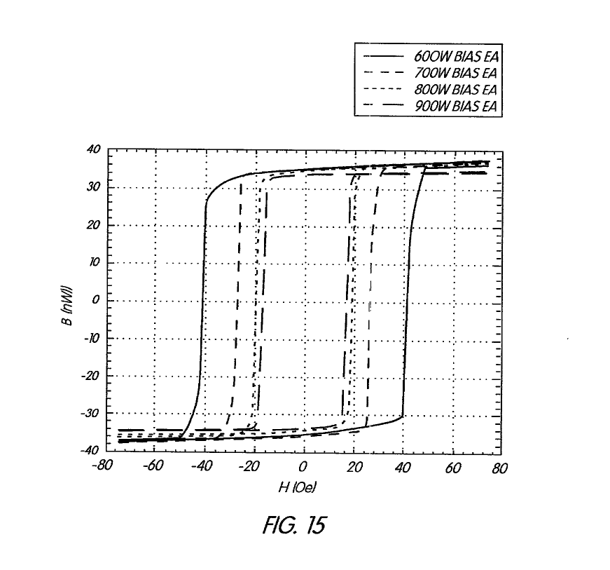

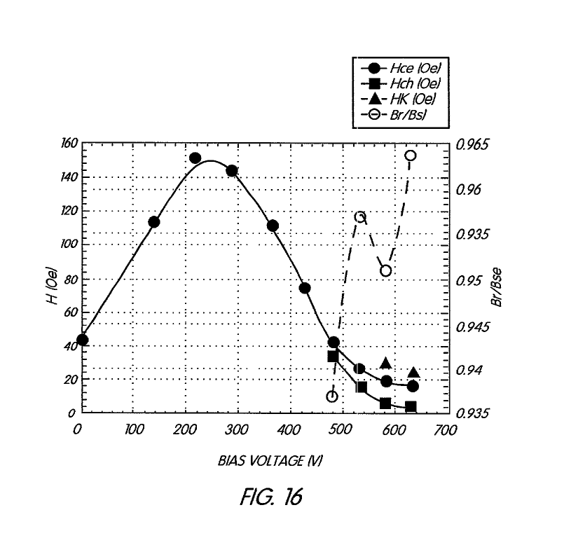

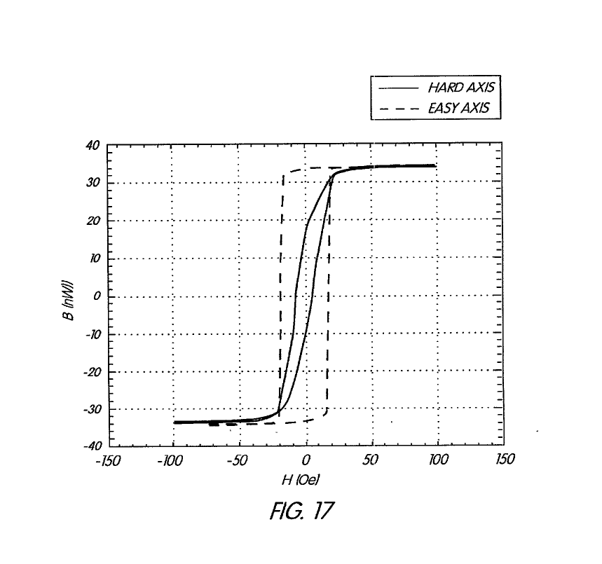

An additional experiment was performed using a production deposition system. The film consisted of sputtered 2.4T FeCo. The Fe₆₅Co₃₅ films were grown at a deposition pressure of 3 mtorr and 750W for 130 seconds as a function of bias powers from 0 to 900W. FIGS. 14 and 15 show the MOKE loops for these samples as a function of bias power. The trends shown in FIGS. 14 and 15 are clear. With increasing bias, the coercivity initially increases and then decreases. FIG. 16 shows coercivity, uniaxial anisotropy, and squareness as a function of bias voltage. As can be seen from FIG. 16, H_{C} peaks at about 250V and then decreases significantly. At the high end, near 900W of bias power, the films are magnetically soft and uniaxial. FIG. 17 shows the BH loops for the easy and hard axes of the sample at 900W (630V) bias power. The easy and hard axis coercivities are 17.4 Oe and 4.2 Oe respectively, with an H_{K} of ˜26 Oe, well within the parameters necessary for the material to be used as the top write pole of a recording head.

While several specific exemplary embodiments of the invention have been described in detail, it will be appreciated by those skilled in the art that various modifications and alternatives to the embodiments presented herein could be developed in light of the overall teachings of the disclosure. Accordingly, the particular arrangements and processes disclosed herein are meant to be illustrative only and not limiting as to the scope of the invention, which is to be given the full breadth of the appended claims and any and all equivalents thereof.

1. A method for forming a magnetically anisotropic alloy of iron and cobalt comprising:
forming said alloy by ambient temperature physical vapor deposition in the presence of a biasing voltage such that said alloy exhibits uniaxial properties.

2. The method of claim 1 wherein said iron cobalt alloy has a magnetic moment of approximately 2.35T or greater.

3. The method of claim 2 wherein said iron cobalt alloy is Fe₆₅Co₃₅.

4. The method of claim 2 wherein said biasing voltage is at least approximately −400V.

5. The method of claim 4 wherein the biasing power is in the radio frequency range.

6. The method of claim 4 wherein easy and hard axis are formed in said alloy approximately 90 degrees apart.

7. The method of claim 1 wherein said alloy exhibits an average grain size which is less than the magnetic exchange length of the material.

8. The method of claim 1 wherein the coercivity along the hard axis of said alloy is less than approximately 10 Oe.

9. 1.The method of claim 8 wherein the alloy becomes magnetically saturated along the hard axis at approximately 30 Oe.

10. A magnetically anisotropic alloy of iron and cobalt which has been formed by ambient temperature physical vapor deposition in the presence of a biasing voltage of at least approximately −400V.

11. The alloy of claim 10 which exhibits a uniaxial anisotropy, having an easy and hard axes approximately 90 degrees apart.

12. The alloy of claim 11 wherein the coercivity along the hard axis of said alloy is less than approximately 10 Oe.

13. The alloy of claim 10 wherein said alloy exhibits a tensile film stress.

14. The alloy of claim 10 wherein the alloy becomes magnetically saturated along the hard axis at approximately 30 Oe.

15. A magnetically anisotropic alloy of iron and cobalt which has been formed by ambient temperature physical vapor deposition in the presence of a means for increasing the saturation magnetization of said alloy.

16. The alloy of claim 15 wherein said means for increasing the saturation magnetization of said alloy is a biasing voltage.

17. The alloy of claim 15 wherein said biasing voltage is at least approximately −400V.

18. A disc drive system comprising:
a magnetic media; and
a recording head having a perpendicular geometry, said recording head comprising:
a reading portion; and
a writing portion having a write tip composed of an alloy of iron and cobalt.

19. The disc drive system of claim 18 wherein said alloy of iron and cobalt has been been formed by ambient temperature physical vapor deposition in the presence of a biasing voltage;

20. The disc drive system of claim 19 wherein said biasing voltage is at least approximately −400V.
